(19) United States
(12) Patent Application Publication
(10) Pub. No.: US 2005/0186500 A1
(43) Pub. Date: Aug. 25, 2005

(54) Method of making and structuring a photoresist

(76) Inventors: Anja Voigt, Berlin (DE); Marina Heinrich, Berlin (DE); Gabi Gruetzner, Berlin (DE)

Correspondence Address: Law Offices of Karl Hormann, P.O. Box 381516, Cambridge, MA, 02238-1516, US

(21) Appl. No.: 10/947,121

(22) Filed: Sep. 21, 2004

(30) Foreign Application Priority Data
Feb. 21, 2004 (DE) 10 2004 009 536.1

(51) Int. Cl. G03C 1/492

(52) U.S. Cl. 430/270.1

(57) ABSTRACT

A method of producing and structuring a UV 300/400 light sensitive highly viscous, chemically amplified positive photoresist which can be developed in an aqueous alkaline medium for application in layers of a thickness of 100 μm or more and which can be removed without leaving any residue, for use in micro systems technologies.

### BACKGROUND OF THE INVENTION

1. Field of the Invention

The invention, in general, relates to a method of making a novel photoresist and, more particularly, to a method of making a UV 300/400 light sensitive photoresist capable of forming layers of 100 μm thickness and above which can be developed in an aqueous alkaline medium and which can subsequently be removed without leaving any residue.

2. The Prior Art

The number of lithographic applications for producing micro electro-mechanical systems in the field of micro systems technology (MST) which require photoresists capable of forming layers as thick as 100 μm and above and which generate vertical profile structures of good aspect ratio and low micro-roughness is growing continually. The increased demands in respect of accuracy and precision of these micro-mechanical, micro-optical and micro-fluidic components can as a rule only be satisfied by the different variants of lithography, electroforming and molding by means of x-ray radiation or UV irradiation. Hence, the availability of corresponding light-sensitive materials and simple processing technologies therefor is becoming ever more significant for applications in the MST market.

Such commercially available positive photoresists as the AZ resists (AZ PLP 100/50/(XT), AZ P4000-, AZ 9200-series) of the Clariant Company, SJR 5740 and SPR 220 of the Shipley Company, THB Positiv of JSR Microelectronics and ma-P 100 of the Assignee of the instant invention are positive resists based upon DNQ/Novolak of broad sensitivity at UV 300/400. These resist systems make it possible to produce, by single-layer spin coating, layers of up to 80 μm thickness. Layers of a thickness of 100 μm capable of structuring can only be formed by multiple coating. For exposing layers of high thickness, these resists which can be developed in aqueous-alkaline media, require high dosage values, i.e. long exposure intervals. Owing to a lack of transparency, the border of exposure penetration of large thicknesses lies in the range of no more than 100 μm. At multiple coatings the lithographic process is rendered more complex by additional steps of forming the layers and their drying. Beginning at a resist thickness of 60 μm these resist systems are incapable to produce the vertical profile edges requisite of UV-depth lithography.

Negative photoresists which are developed in an aqueous alkaline material consist of a phenolic resin as a polymeric binder and an aromatic bis-azide as the light-sensitive component for determining the sensitivity of the resist system, dissolved in a solvent or solvent mixture. The exposure penetration of these resist systems is restricted to a maximum of 20 μm because they do not bleach out at an exposure in the exposure wavelength range. At these layer thicknesses, only a very low resolution is possible and the edges display an undercut profile structure which is unsuitable for the molding of precision components.

Under the pressure of increasing miniaturization in micro-electronics in respect of low layer thicknesses (<1 μm) for wave lengths in the DUV range and below (193 nm and 157 nm), resist systems based upon the concept of chemical amplification (chemically amplified resist=CAR) have been conceived with a view to increasing resolution. The high sensitivity of these resist systems is rooted in their reaction mechanism which causes the change in solubility in the exposed relative to the unexposed areas which is initiated at the exposure and subsequent tempering or annealing) (post exposure bake=PEB) of the resist layers. When such a resist layer is exposed, a proton is generated (photo acid generator=PAG) which, in the case of a positive photoresist, initiates a polymer chain cleavage or splitting off of functional groups or which, in the case of a negative photoresist, initiates a cross-linking reaction of the polymeric/oligomeric matrix. As the final product, in addition to the product of higher solubility in the developer (positive resist) or lower solubility (negative resist), a further proton is generated which may lead to a renewed cleavage reaction. A photo-chemically generated proton repeatedly causes a cleavage or cross-linking reaction. Chemical amplification factors (i.e. the number of cleaved functional side groups at the polymer per photolytically generated proton) of 50-500 have been described. The effectiveness of the cleavage or cross-linking reaction is influenced by the polymer/PAG ratio, the exposure dose and by the tempering conditions.

Many of the positive photoresists with chemical amplification are based upon a polyhydroxy styrene (PHOSt) partially substituted by acid-sensitive groups. Owing to its transparency and resistance to etching, PHOSt was the polymer of choice for the development of chemically amplified DUV-248 nm positive resists.

In acetal and ketal substituted PHOSt as representative of low activation energy chemically amplified resists, the splitting-off of the acid-sensitive groups takes place spontaneously after or during exposure at room temperature. In this case, there is no need for the post exposure baking step. These resist systems often suffer from an insufficient stability in respect of the line width and low storage stability.

With copolymers of HOSt and tert.-butylacrylate (tert.-BuA) as representative of high activation CAR's, tempering takes place without degradation of the photo material at high temperatures in accordance with the annealing concept.

The monomers for a polymer are selected in dependence of the functionality of the photo-resists to be formulated. Thus, monomer units must contain acid-sensitive functional groups which in consequence of exposure and subsequent tempering (PEB) cause a change in solubility. Monomers containing hydroxyl groups enhance the formation of layers and increase the PAG solubility to some extent. While a small proportion of monomer units improves the etching stability of the photo material, it also leads to an increase of the absorption in the range of DUV wave lengths. For that reason, monomers containing cyclic aliphatic groups were incorporated into the polymer instead of monomers containing aromatics. By using acrylates, for instance (iso)bornyl adamantyl (meth)acrylate, the high transparency in the DUV range and below is maintained, in addition to good etching stability, at exposure wave lengths.

Compounds which generate acids/protons when exposed are, above all, salts of onium, and special sulfonium and iodonium salts. By the corresponding selection of the cation (number and kind of aromatics) and of the anion (responsible for the solubility in the resist solvents and for the acidic strength of the acid generated by chemical initiation,) properties such as absorption, sensitivity and contrast of the photo material to be represented are codetermined. High thermal stability must be one of the properties of the PAG's, for neither the PAG not the acid generated must dissipate from the layer during the tempering process.

To avoid the formation of a T-top or film at the structures observed during processing of positive CAR's, additives are incorporated into the resist formulation in addition to using protective resist layers or low activation CAR's. These additives usually consist of a basic compound in combination with an acid compound.

Making use of the concept of chemical amplification constitutes a significant potential for forming high layers of highly sensitive photoresists to satisfy the demands of micro systems technologies the MST.

Structures of high aspect ratios and steep edge profiles in very large layer thicknesses can be produced by photoresists the photosensitive reaction of which is carried out on the basis of a cationic polymerization of peroxidized bis-phenol-A-formaldehyde novolak resins. This system which after an exposure and PEB step is strongly cross-linked is developed by a solvent and after the transfer of the structure, can only be removed with difficulties. Penetrating exposures in the shortest possible time of layers of 100 μm and greater thickness are made possible because of the high transparency of the layer-forming component and of the low proportion of any acid generator (PAG).

Hitherto, no highly viscous positive photoresists have become known which are capable of forming high layers, which are sensitive to UV 300/400 radiation, can be processed in a simple manner, and which can be developed in an aqueous alkaline medium and which, moreover, satisfy the demands of micro systems technologies in respect of the quality of edge profiles, and which after structure transfer can be removed without leaving any residue.

### OBJECTS OF THE INVENTION

It is an object of the invention to provide a highly viscous positive Photo resist.

Another object is to provide a photoresist of the kind referred to which is UV 300/400 light sensitive.

A further object of the invention is to provide a photoresist capable of forming layers of a thickness of 100 μm and above.

Still another object of the invention resides in the provision of a highly viscous chemically amplified photoresist capable of forming layers of a thickness of 100 μm and above which can be processed in an aqueous alkaline medium.

Yet another object of the invention is to provide a Photoresist comprising a low molecular polymeric matrix and a light sensitive proton acid generator a solvent medium and layer forming additives.

A still further object is to provide a method of producing and structuring a resist wherein the formed resist structure is suitable to assume an electroform for galvanic precipitation.

It is also an object of the invention to provide a resist which after structure formation can me removed without leaving any residue.

### BRIEF SUMMARY OF THE INVENTION

The low molecular polymeric matrix is composed of monomers suitable to impart to the resist predetermined functions. Without limitation, among these are acid sensitive protective groups, hydroxyl groups improving adhesion of the resist to a substrate, aromatics for increasing etching stability and layer-forming substances. The co-, ter-, and tetra-polymers may be produced by simple polymerization by the addition of a radical initiator. The low molecular polymeric compounds can be dissolved in acetone so that the resist may be easily compounds can be dissolved in acetone so that the resist may be easily removed after structure transfer is completed. The low solubility of the low-molecular polymeric compound in aqueous solutions from an extremely acidic to an extremely alkaline pH-range constitutes a significant advantage as to the galvanic precipitation of metals in the context of the LIGA process, i.e. a process of X-ray lithography, electroforming and molding.

The solids content of the resist solution may be very high because of the low molecular weight of the polymers used. The resist solution is highly viscous and forms homogeneous layers.

Suitable photo initiators for cationic cleavage of the acid-sensitive functional groups (protective groups) are known initiators, such as, for example, sulfonium-, iodonium-, and phosphonium salts which are added to the polymer solution in concentrations of 2-30% by weight, preferably 3-15% by weight. The usual initiators are triarylsulfonium hexafluoroantimonate, triarylsulfonium-hexafluorophosphate or mixtures of triarylsulfonium hexafluoroantimonate and thiophenoxy triarylsulfonium hexafluoroantimonate, which are commercially available from The General Electric Company under the trade name UVE or from Union Carbide Corporation under the trade names UVI-6974 and UVI-6990. The resist layers are sensitive in the UV 300/400 spectral range and can be exposed by extreme pressure lamps, lasers and X-ray sources.

The high transparency of the polymer matrix to wavelengths in the exposure range coupled with the reaction mechanism of the chemical amplification makes it possible to structure layers of large thicknesses.

The use of non-reactive softeners in the resist leads to high layers which can be structured and which are free of tension free and cracks. The use in the resist of a buffer system prevents the formation of structures with a T top.

Advantageously, the solvents used in the resist are non-toxic. The selected material combinations are dissolved in organic solvents, for instance, propylene glycol monomethyl etheracetate (PGMEA), propylene glycol monomethylether (PGME), anisol and coating is carried out by conventional process techniques, such as, for instance, spinning, knife applications or pouring.

After exposure and a subsequent tempering step, the solubility of the polymer matrix is changed which makes development in an aqueous alkaline solutions possible. The use of environmentally friendly water-based developers is particularly advantageous.

The resist described in the context of the invention is suitable in a lithographic process to generate structures of a thickness between 5 μm and 2 mm and an aspect ratio >8. The structures are of great dimensional stability (1:1 transfer of the structure from the mask in the resist). They also have a high edge steepness up to 89° and a low edge roughness, and they are suitable for providing a stable basis for a galvanic molding.

### PREFERRED EXAMPLES OF THE INVENTION

The invention will be set forth in greater detail with reference to the following examples.

Polymer Syntheses

The following abbreviations will be used for the monomers used: methyl/butyl methacrylate—M/BuMA, methacrylic acid—MAA, tert.-butylmethacrylate—tert.-BuMAltert.-BuA, Styrene—St. The initiator used was 2,2′-azobisisobutyronitrile—AIBN.

### EXAMPLE 1

### Synthesis of poly-(tert.BuMA/MAA/St)

6.785 g of tert.-BuMA, 5.45 g of MAA, 4.94 g of St and 1.04 g of AIBN are dissolved in 170 g of acetone in a three necked flask provided with a stirrer motor, a reflux cooler and an inert gas feed. After stirring for 20 hours under reflux in an inert gas atmosphere (nitrogen), the polymer is obtained by precipitating the clear, colorless reaction solution of higher viscosity in water, followed by syphoning off and drying. The polymer is purified by reprecipitation in an acetonic solution in water, syphoned off and dried at 70° C. in a vacuum.

Yield: 12.0 g (70.1%) of white powder; Mw: 8,550 g/mol; T_{g}: 101° C.; T_{d}: 246° C.; Fₚ: 155-158° C.

### EXAMPLE 2

### Synthesis of poly-(tert.-BuA/MAA/MMA/St)

The protocol of the synthesis is analogous to that of Example 1, using the following monomers and proportions in the monomer mixture: Using 15 g of tert.-BuA, 6.72 g of MAA, 7.8 g of MMA, 12.18 h of St and 2.4 g of AIBN in 315 g of acetone, 22.8 g (yield 54.7%) of a white powder are obtained after a reaction time of 26 h.

Mw: 9, 100 g/mol; T_{g}: 101° C.; T_{d}: 252° C.; Fₚ: 126-129° C.

### EXAMPLE 3

### Synthesis of poly-(tert.-BuA/MAA/BuMA/St)

The protocol of the synthesis is analogous to that of Example 1 using the following monomers and proportions in the monomer mixture: Using 15 g of tert.-BuA, 6.72 g of MAA, 11.1 g of BuMA, 12.18 g of St and 2.40 g of AIBN in 315 g of acetone yielded 28.7 g (Yield 63.8%) of a white powder after a reaction time of 26 h.

Mw: 10,500 g/mol; T_{g}: 107° C.; T_{d}: 250° C.; Fₚ: 97-101° C.

### EXAMPLE 4

### Synthesis of poly-tert.-BuMA/MAA/MMA/St)

The protocol of the synthesis is analogous to that of Example 1, using the following monomers and proportions in the monomer mixture: Using 25 g of tert.-BuMA, 8.65 g of MAA, 10.06 g of MMA, 13.08 g of St and 3.09 g of AIBN in 400 g of acetone resulted in 52.97 g (yield 93.3%) of a white powder.

Mw: 8,000 g/mol; T_{g}: 107° C.; T_{d}: 252° C.; Fₚ: 118-121° C.

In the resist batches the following abbreviations are used for the solvents and for the additives: propylene glycol monomethyl etheracetate—PGMEA, propylene glycol monomethyl ether—PGME, methoxybenzene/anisol—MOB, cyclohexanon—CH, triethanolamine—TEA, salicylic acid—Sacr, IPA—isopropyl alcohol.

### EXAMPLE 5

Resist Batch 1

75 g of poly-(tert.-BuMA/MAA/MMA/St) are dissolved in 75 g of a solvent mixture (PGMEA:MOB:CH=80:10:10 [in % by weight] spiked with 0.6 g of polyether-modified polydimethylsiloxane, 0.19 g of TEA, 0.17 g of Sasr and 7.5 g of a non-reactive softener. Thereafter, 19.5 g of an onium salt solution are stirred into the clear solution. The result is 150 g of resist with a solids content of 50% by weight.

### EXAMPLE 6

Resist Batch 2

75 g of a partially tert.-Butyloxycarbonyl-substituted phenolic resin (produced according a known synthesis protocol [a. W. Brunsvold; W. Conley; P. R. Varansai; M. Khojasteh; N. Patel; A. Molles; M. Neisser; G. Breyta: SPIE Vol. 3049 (1997), p. 372; and b. F. Houlihan; F. Bouchard; J. M. J. Frechnet; C. G. Willson: Can. J. Chem. 63, 153 (1985), p. 153] are dissolved in 75 g of a solvent mixture (PGMEA:MOB:CH=80:10:10 [in % by weight]) spiked with 0.37 g of a polyether-modified polydimethylsiloxane and 2.25 g of a non-reactive softener. Thereafter, 15 g of an onium salt solution are stirred into the clear solution. 150 g of resist with a solids content of 50% by weight were obtained.

### EXAMPLE 7

Resist Batch 3:

75 g pf poly-(tert.-BuA/HOSt/St) were dissolved in 75 g of a solvent mixture (PGMEA:PGME=70:30 [in % by weight]) spiked with 0.375 g of polyether-modified polydimethylsiloxane, 0.19 g of TEA, 0.17 g Sasr and 3.75 g of a non-reactive softener. 11.25 g of an onium salt solution are stirred into the clear solution. 150 g of resist with a solids content of 50% by weight are obtained.

### EXAMPLE 8

4″ silicon wafers prepared with HMDS as coupling agent are spin-coated for 60 s with a resist according to Example 5. The layers obtained are dried in an oven at 90° C. and are then exposed in the manner of an image with US 300/400, and then tempered at 120° C. (ramp of 80° C.) and developed in 0.2 N NaOH (see Table).

| Rotations [rpm] | Layer Thickness [μm] | Dosage_{365 nm} [mJ/cm²] |
|---|---|---|
| 500 | 50 | 3100 |
| 1000 | 35 | 2800 |
| 3000 | 15 | 2000 |

### EXAMPLE 9

4″ silicon wafer pretreated with HMDS as coupling agent are spin-coated with a resist according to Example 6 for 60 s. The layers obtained are dried in an oven at 90-100° C. and are thereafter exposed in an imagewise manner with UV 300/400 and then tempered at 125° C. and developed in 0.25 N NaOH with IPA additive. (See Table).

| Rotations [rpm] | Layer Thickness [μm] | Dosage_{365 nm} [mj/cm²] |
|---|---|---|
| 1000 | 17 | 1200 |
| 3000 | 8.5 | 1000 |

### EXAMPLE 10

4″ silicon wavers pretreated with HMDS as a coupling agent are spin-coated with a resist according to Example 7 for 60 s. The layers obtained are dried in an oven at 95° C. and then exposed in an imagewise manner with UV 300/UV400, thereafter tempered at 120° C. [ramp of 80° C.] and developed in 0.15

NaOH (see Table).

| Rotations [rpm] | Layer Thickness [μm] | Dosage_{365 nm} [mJ/cm²] |
|---|---|---|
| 300 | 150 | 4800 |
| 500 | 90 | 3300 |
| 1000 | 55 | 2000 |
| 3000 | 21 | 800 |

### EXAMPLE 11

Electroplating with Resist 1

In a galvanic mold of resist 1 corresponding to Example 8 with a layer thickness of 48 μm on a substrate coated with gold, nickel in a bath of nickel sulfamate (pH=3.5) is galvanically precipitated at a temperature of 55° C. and at 300-400 mA with a thickness of 30 μm, and the resist is subsequently removed with acetone.

### EXAMPLE 12

Electroplating with Resist 3

In a galvanic mold of resist 3 corresponding to Example 10 with a layer thickness of 50 μm on a substrate coated with gold, nickel in a bath of nickel sulfamate (pH=3.5) is galvanically precipitated at a temperature of 55° C. and at 300-400 mA with a thickness of 45 μm, and the resist is subsequently removed with acetone.

1. A process of making and structuring a UV 300/400 light sensitive highly viscous and chemically amplified positive resist for processing in an aqueous alkaline medium for use in micro systems technology, especially for micro electroplating, comprising the steps of:
providing a resist containing a low molecular polymer matrix provided in its side chains acid catalyzed cleavable protective groups, a light-sensitive acid generator, one of a solvent and solvent mixture and one of layer-forming and layer-stabilizing additives;
applying the resist as a layer on a substrate;
drying the resist;
exposing the resist in an image-wise manner at a wavelength range of 200 to 500 nm;
tempering the resist;
developing the resist in an aqueous alkaline developer;
utilizing the lithographically produced resist structures for fabricating galvanically molded structures in the range of 5 μm to 2 mm; and
thereafter removing the resist structures.

2. The method of claim 1, wherein the polymer matrix has a molecular weight of up to 20,000 g/mol and contains in its side chains acid catalyzed cleavable protective groups.

3. The method of claim 1, wherein the polymer matrix comprises from 2 to 4 different monomer components comprising:
20-75% acid catalyzed cleavable protective groups;
10-35% OH groups for improving bonding on substrates;
10-50% monomer components containing aromatics; and
10-50% layer-forming monomer components.

4. The method of claim 3, wherein the monomer components perform more than one function.

5. The method of claim 1, wherein the resist contains solids of 35 to 80% by weight of the low molecular polymer matrix.

6. The method of claim 1, wherein the light-sensitive acid generator is an alkyl-amyl-onium salt of the general formula 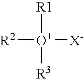
wherein:
O is one of sulfonium and iodonium;
R¹, R2, R³ are cross-linked and non-cross-linked alkyl-,/aryl- or alkyl- and aryl-substituted aromatics; and
X is, for instance, at least one of -hexafluoroantimonate, -hexafluorophosphate, and -trifluoromethanesulfonate.

7. The method of claim 5, wherein the proportion of light-sensitive acid generator is 2 to 30% by weight of the solids.

8. The method of claim 1, wherein the solvent comprises at least one of ester, ketone, alcohol and aromatics.

9. The method of claim 1, wherein the layer forming or layer stabilizing additive is at least one of a tenside, smoother, bonding agent, non-reactive softener and system soluble in alkali.

10. The method of claim 1, wherein the layer is formed by one of spin-coating, dipping, roller coating and casting.

11. The method of claim 1, wherein the exposure is carried out by one of high pressure lamp, laser and x-ray radiation.

12. The method of claim 1, wherein the developing is carried out by an alkali metal ions containing developer of a concentration of from 0.2% by weight to 1.5% by weight.

13. The method of claim 1, wherein the developing is carried out by a metal ion free containing developer of a concentration of from 1% by weight to 5% by weight.

14. The method of claim 1, wherein the lithographically produced resists structures are useful for fabricating galvanically molded structures in baths of a pH from 1 to 13 at temperatures between room temperature and 80° C.

15. The method of claim 1, wherein the lithographically produced resist structures are removed after galvanic molding without leaving any residue.
